(19) United States
(12) Patent Application Publication
(10) Pub. No.: US 2026/0311581 A1
(43) Pub. Date: Oct. 8, 2026

(54) ASSET TRACKING SYSTEM

(71) Applicant: Aware Innovations, LLC, West Carrollton, OH (US)

(72) Inventors: Charles E. Evanhoe, West Carrollton, OH (US); Daniel E. Freeman, West Carrollton, OH (US); John W. McGinn, West Carrollton, OH (US); Joseph C. Mock, West Carrollton, OH (US)

(21) Appl. No.: 19/457,449

(22) Filed: Jan. 23, 2026

Related U.S. Application Data
(60) Provisional application No. 63/749,350, filed on Jan. 24, 2025.

(51) Int. Cl. G08B 13/24

(52) U.S. Cl. CPC G08B 13/2462

(57) ABSTRACT

A process of tracking comprises configuring a reader to wirelessly communicate with tags within an asset-tracking space and a task identifying a tag that is associated with an asset of interest. A sensor detects that the task has commenced by determining that an asset has been placed on an asset conveyance mechanism. The reader receives information (including identifier data) from the tags, and signal strength data for the tags is also obtained by the reader. The sensor detects that task has ended when the asset has been removed from the asset conveyance mechanism. Packets are created including the identifier data and signal strength data for the tags at a specific time. The packets are evaluated by identifying which of the tags that are present within a select one or more of the packets and surpass a signal strength threshold. Then a predetermined action based on the evaluation is performed.

### CROSS-REFERENCE TO RELATED APPLICATIONS

This application claims the benefit of U.S. Provisional Patent Application Ser. No. 63/749,350, filed Jan. 24, 2025, having the title ASSET TRACKING SYSTEM, the entire disclosure of which is hereby incorporated herein by reference.

### BACKGROUND

### Field of the Invention

Various aspects disclosed herein relate generally to tracking an asset using a wireless communication system, and more particularly to tracking the asset utilizing systems to implement mobile environment data capture.

### Description of the Related Art

Radio-frequency identification (RFID) is a technology that utilizes electromagnetic fields to convey information. In this regard, a typical RFID system requires two separate components, including a radio reader and a transponder (which is commonly integrated into a tag). The RFID reader outputs an electromagnetic pulse. If a transponder (e.g., in the form of a tag) is in range of the electromagnetic pulse, that transponder sends data back to the RFID reader. The conveyed data can be as simple as a unique code, which can be associated with any desired data in a corresponding database. Notably, a tag may be passive or active. A passive transponder is powered by energy from the RFID reader's electromagnetic pulse. Active tags are powered by a battery or other power source, extending the range and/or amount of data that can be conveyed in cooperation with a corresponding RFID reader, compared to a passive tag.

### SUMMARY

According to aspects of the present disclosure, a process of tracking comprises configuring a reader to wirelessly communicate with tags within an asset-tracking space and a task identifying a tag within the asset-tracking space that is associated with an asset of interest. A sensor detects that the task has commenced by determining that an asset (not necessarily the asset of interest) has been placed on an asset conveyance mechanism. The reader receives information (including identifier data) from the tags, and signal strength data for the tags is also obtained by the reader. The sensor detects that task has ended when the asset has been removed from the asset conveyance mechanism. Packets are created including the identifier data and signal strength data for the tags at a specific time. The packets are evaluated by identifying which of the tags that are present within a select one or more of the packets and surpass a signal strength threshold. Then a predetermined action based on the evaluation is performed.

According to further aspects of the present disclosure, a process of tracking comprises configuring a reader to wirelessly communicate with tags within an asset-tracking space and a task identifying a tag within the asset-tracking space that is associated with an asset of interest. A sensor detects that the task has commenced by determining that an asset (not necessarily the asset of interest) has been placed on an asset conveyance mechanism. The reader receives information (including identifier data) from the tags. The sensor detects that task has ended when the asset has been removed from the asset conveyance mechanism. Packets are created including the identifier data for the tags at a specific time. The packets are evaluated by identifying which of the tags that are present within a select one or more of the packets. Then a predetermined action based on the evaluation is performed.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 depicts a tracking system, according to various aspects of the present disclosure;

FIG. 2 depicts details of the information processing device that is depicted in FIG. 1, and which is either signally cooperates with or is formed as a part of the tracking system, according to various aspects of the present disclosure;

FIG. 3 is a flowchart illustrating a process for tracking an asset of interest, according to various aspects of the present disclosure;

FIG. 4 is a timing diagram associated with an example of the process of FIG. 3 according to various aspects of the present disclosure;

FIG. 5 is a flow illustrating tracking assets, according to various aspects of the present disclosure; and

FIG. 6 is a flow illustrating tracking assets in an environment, according to various aspects of the present disclosure.

### DETAILED DESCRIPTION

Aspects herein relate to overcoming the traditional problem of tracking an asset within an environment (such as a warehouse) where numerous other assets are also situated. The technical solution as disclosed herein provides a data capture approach, which may leverage telematics and/or other technical data collection and processing techniques, to track the asset in a timewise and/or data-wise efficient manner.

Notably, a traditional reader (e.g., a radio frequency identification (RFID) reader), uses an antenna to output an electromagnetic pulse. The electromagnetic pulse serves as a stimulus to cause corresponding tags (e.g., RFID tags), to transmit data, which can then be sensed/read back by the reader. In the case of simple passive tags, the returned data can be as simple as a unique identifier (e.g., Universally Unique Identifier—UUID). In the case of active tags, the amount of data can increase, and/or the data can be more complex. Regardless, in environments with significant numbers of tags, it can become overwhelming to keep track of the encountered tags. Moreover, because of conventional antenna technology, a typical reader can determine proximity, but not precise location. As such, a typical reader cannot precisely determine where each detected tag is located.

According to aspects of the present disclosure, while a task is being performed, which concerns an asset of interest (e.g., transporting a pallet from one location or another), tags are detected by the reader. Then, a processor evaluates which tags are present, absent, changing in signal strength, a combination thereof, etc., at discrete points or otherwise throughout the task. For instance, the processor can evaluate which tags are present at two discrete times during the task (which may include immediately before the task starts and/or after the task ends). From that determination, the processor can derive if the task was performed on the correct asset of interest.

By way of introductory example, if tag A is located on a pallet and the task is for a forklift truck to pick up the pallet, move the pallet from one location to another, and drop the pallet (such as may be typical in a warehouse operation), then tag A should be read at every sampling time during the task, because the pallet will be on the forklift from the beginning of the task to the end of the task. Moreover, the signal strength of tag A should stay relatively consistent while the forklift is holding the pallet (accounting for the relationship between the forks of the forklift and corresponding reader on the forklift). Other tags (i.e., tags that are not tag A) may not be present during the entire task, because those tags may go in or out of range as the forklift truck moves throughout the warehouse. As another example, the signal strength of a tag may vary during the task, indicating that the reader is getting closer or further away from that tag (implying that that tag is not maintaining a steady (or relative) relationship with the reader).

In practical applications, a basic asset tracking system (e.g., RFID) can be used to verify that the correct assets have been picked up and moved to the correct destination.

Moreover, because the RFID reader is capable of reading numerous tags in the vicinity of the reader, aspects herein can combine the above with additional technologies, such as extrinsic sensors, environmental sensed information, etc., to locate, triangulate, validate, audit, or otherwise detect the presence, proximity, location, or combinations thereof, of assets encountered by the reader, as described more fully herein.

### Introduction to an Asset Tracking System

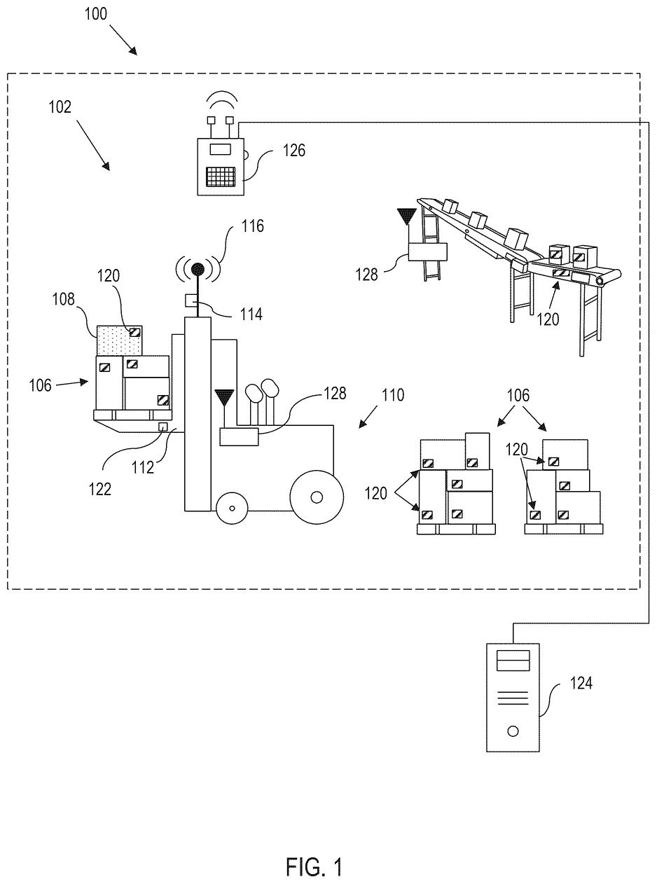

Referring initially to FIG. 1, a tracking system 100 is disclosed that operates within an asset-tracking space 102. In practical applications, the asset-tracking space 102 can correspond to a warehouse or related environment where numerous assets are situated. However, aspects herein are not limited to warehouse environments. Rather, the asset-tracking space 102 can include, by way of further example, a manufacturing facility, a distribution center, a retail establishment, a government facility, a convention center, a storage or archival facility, or any other location where it is desirable to track numerous assets.

The asset-tracking space 102 can include numerous assets 106. In this regard, assets 106 can include, for example, individual items, boxes or totes of items, pallets of items, etc. Thus, assets 106 may be positioned on a floor, on a pallet, stored in a racking system, situated on a conveyor, stationed in a work area, etc.

It will be appreciated that when a particular asset is being identified, sought or tracked, that asset is referred to more particularly as an asset of interest 108 (e.g., a crate, a pallet, a box, another container, etc.), the meaning of which will become apparent from the context of the disclosure herein.

The tracking system 100 is particularly useful in conjunction with an asset conveyance mechanism 110 having a load handler 112. By way of example, the asset conveyance mechanism 110 can be configured as a mechanized mobile device, such as a truck (including pallet truck), forklift, automated guided vehicle, pallet jack, reach truck, tow motor, cart, tractor, tow vehicle, or other industrial vehicle. In this regard, the load handler 112 can comprise forks, a trailer, a bed or platform, or any other structure intended for moving assets 106. In some embodiments, the asset conveyance mechanism 110 is a fixed device that moves assets such as a conveyor system.

For sake of explanation, the illustrated asset conveyance mechanism 110 is shown as a forklift truck having a load handler 112 implemented as forks.

The tracking system 100 also includes a tag reader (or more simply, reader) 114 that is integral and/or native to, affixed to, disposed on, secured to, uniquely associated with, or otherwise mounted on the asset conveyance mechanism 110. The reader 114 is electrically connected to at least one antenna 116.

In one form, the antenna 116 is used to transmit and/or receive wireless signals. In this regard, each antenna may be configured as an omnidirectional antenna, or as a directional antenna (including a linear, cardioid, super-cardioid, FIG. 8, etc., antenna pattern that has orientation-specific sensitivity).

Numerous tags 120 are situated within the asset-tracking space 102 where at least one of the tags 120 is affixed to, disposed on or otherwise secured to the asset of interest 108. Not all shown tags are labeled, solely for clarity of illustration. Here, each small box with lower left to upper right slanted hash shading indicates an RFID tag.

In this regard, RFID tags 120 can be applied to just about anything, e.g., boxes/packages, pallets, racks, machines, etc. For instance, the passive nature of RFID tags enables such tags to be made small and relatively flat, often being secured to boxes, etc., using pressure-sensitive adhesives (like film or foam-backed labels). Manufacturers can also directly integrate an RFID tag into materials (e.g., known as “source tagging”), such as cardboard for integral tagging and packaging.

Moreover, as illustrated, a second sensor 122 is disposed on the asset conveyance mechanism 110 and is configured to detect at least one parameter (such as location) associated with the asset of interest 108. Here, the second sensor 122 can be an RFID reader or other technology (e.g., proximity detector, etc.).

An information processing device 124 can be used to provide computer control of at least a portion of the tracking system 100. By way of example, processing and communication can include or otherwise be orchestrated by local processing devices, one or more remote processing devices, or a combination thereof. For instance, as illustrated, a remote information processing device 124 (e.g., a remote server) is provided, which can be utilized for processing tag information. In this regard, communication within or by the information processing device 124 may be through wired or wireless means 126 where the latter may include known long-range or short-range approaches such as mobile telephony, Wi-Fi, Bluetooth, nearfield communications, Wi-Fi access points, etc. In some applications, such as where the wireless means 126 comprises a Wi-Fi access point or other wireless access point, the forklift and/or other devices within the environment can include a transceiver 128 that can communicate with the remote information processing device 124 via the wireless means 126 (e.g., access point).

Because of the flexibility of the tags 120, the nature of the asset of interest 108 can be defined in any number of practical ways. For instance, the asset of interest 108 can be a single item. The asset of interest 108 may also be a single package (e.g., a single box). The asset of interest may be several different items packaged together in a box or other suitable enclosure. Aspects herein are also not limited to tagging packages. For instance, pallets, bins, cases and/or other organizational structures can uniquely be identified by a tag 120.

In one form (such as in a warehouse), the asset of interest 108 may itself contain multiple assets. For example, if the asset of interest 108 is a crate, pallet, box or other container, there may be numerous assets of sub-assets within, on, or otherwise associated with such structure.

In one form, the reader 114 acts as a scanner or interrogator of data contained within the tags 120. In one form, a wireless signal communication contains actionable data and is received by the reader 114 as radio frequency identification (RFID) information. As is known in the RFID art, the reader 114 may include a transmitter for modes of operation where the tags 120 function as passive devices. Moreover, when the tags 120 are configured as active devices, the reader 114 may not need to include a transmitter, at least with regard to sending out an identifying control signal between the reader 114 and the tags 120. In one particular form, the reader 114 uses ultrawideband (UWB) RFID. In some forms, the reader includes a barcode reader. In another form, the reader 114 may operate using other signal-conveying technologies such as Wi-Fi, Bluetooth Low Energy (BLE) (as well as other forms of Bluetooth) or other forms of wireless data exchange. In yet another form, the reader 114 uses two or more technologies, examples of which are described herein.

As can be seen, the tags 120 may be distributed throughout the asset-tracking space 102. In a passive mode of operation, the tags 120 act as transponders for wireless radio signals that emanate from the transmitter of the reader 114. It will be understood within the present context that by virtue of being secured to assets (including the asset of interest 108), the tags 120 may have some structural and functional attributes of a beacon and that the terms are used interchangeably unless the context or a specific use dictates otherwise. In one form, the tags 120 act in a more passive capacity insofar as they function to respond to inquiries from the reader 114, while in another form in a more active capacity in that they broadcast information (such as information particular to the asset of interest 108) to, among other devices, the reader 114. In one form, at least the tag 120 that is associated with the asset of interest 108 is (if active) transmitting a signal that broadcasts certain information, such as its identification (and optionally, other information), and (if passive) returns a response to a signal received from the reader 114. It will be understood that the tag 120 that is associated with the asset of interest 108 may also provide additional information, which may include metadata that may be used by the information processing device 124 or other parts of the tracking system 100.

In other example applications, the tags 120 may be configured in other forms, such as barcodes, Bluetooth Low Energy (BLE) beacons, nearfield communication (NFC) labels or related item identification devices. Although not shown, other tags may be placed throughout the asset-tracking space 102. In one form, these additional tags may be in a stationary, known position such that they can act as beacons that can be used as part of a positioning system that can infer the location of the asset conveyance mechanism 110 within the asset-tracking space 102.

The sensor 122 may be a pressure switch, an e-field sensor, a temperature switch, proximity sensor (e.g., inductive sensor, capacitive sensor, ultrasonic sensor, photoelectric sensor, magnetic sensor), RFID reader, weight/load sensor, etc. Here, the sensor 122 may be tasked to determine if an object is on the asset conveyance mechanism 110. However, the sensor 122 may not necessarily know if the object on the asset conveyance mechanism is the asset of interest 108.

Likewise, if the reader 114 or other part of the asset conveyance mechanism 110 is equipped with suitable antennas (such as an array, a rotating antenna, distributed antennas, or the like), angle of attack (AOA), time of arrival (TOA), etc., approaches may be used. In another form, relative strength signal indicator (RSSI) or related signal strength approaches may be used instead of time-based approaches to perform general approximations of distance between the sensor 122 and the tag 120. Relatedly, if the tracking takes place in the asset-tracking space 102 that is accessible to satellite-based geopositioning (such as a global navigation satellite system (GNSS)), then such location-determining means may be used as well.

In one form, the information processing device 124 is situated on the asset conveyance mechanism 110 such that some or all of the information being generated, processed, analyzed or reported takes place locally, while in another is situated at a remote location (such as in a gateway, server, cloud or other information-processing backhaul, collectively designated as a backhaul). Likewise, although the information processing device 124 is presently shown as being remote from the reader 114 and sensor 122 (such that communication therebetween must take place over one or more wired or wireless transmission protocols), it will be appreciated that the information processing device 124 may in another embodiment be collocated with, situated on, commonly packaged with or otherwise physically coupled to one or both of the reader 114 and sensor 122. All such variants of the placement and signal connectivity of the information processing device 124 relative to the reader 114 and sensor 122 are understood to be within the scope of the present disclosure.

In one form, the information processing device 124 and its components are configured to communicate location information related to the asset of interest 108 to the asset conveyance mechanism 110. In response thereto, the asset conveyance mechanism 110 can communicate one or more electronic component(s) of the asset conveyance mechanism 110 in order to allow the asset conveyance mechanism 110 or an operator in control thereof, to perform a responsive action, including (in certain circumstances) a predetermined action, such as modifying a working state of the asset conveyance mechanism 110.

In one form, the reader 114 may be configured as a transceiver that communicates over a wireless connection to the information processing device 124, either directly or through an intermediary device such as the wireless means 126 (e.g., an access point, a hub, the aforementioned gateway, routers, firewalls, network interfaces or the like). Alternatively, the reader 114 may utilize a transceiver on the asset conveyance mechanism 110 (e.g., transceiver 128) to communicate with the remote information processing device 124 as noted above.

Although shown as separate pieces of equipment, it will be appreciated that in one form some or all of the functionality of the reader 114 and sensor 122 may be subsumed into a single device (not shown), and that both forms are deemed to be within the present disclosure. Relatedly, the data being captured from one or more of the tags 120 may be used for multiple purposes.

### Example Processing Device Structure

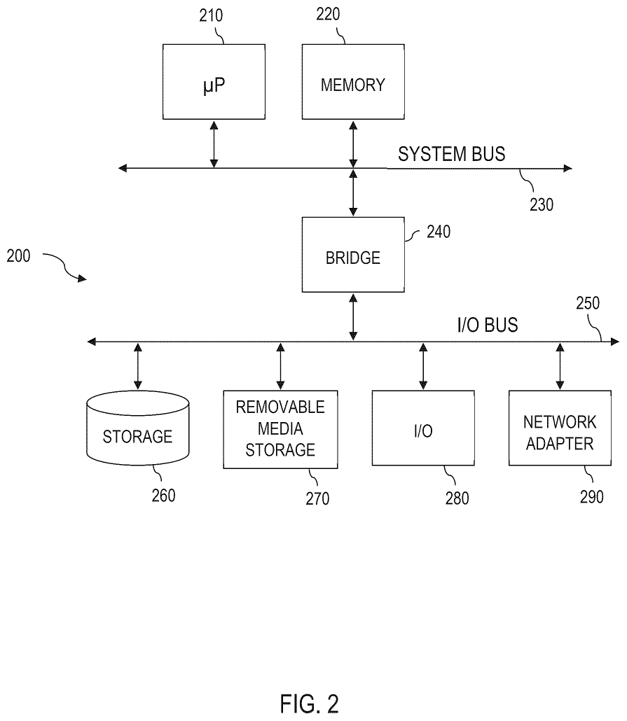

Referring with particularity to FIG. 2, a processing device 200 is illustrated. The processing device can implement, for example, any one or more of the processing devices described with reference to FIG. 1. As such, the disclosure of FIG. 1 is incorporated into the discussion of FIG. 2 in any combination of features unless otherwise noted. By way of example, the processing device 200 can implement the information processing device 124 (FIG. 1). In this regard, the processing device 200 may function as a control circuit that may be used for implementing the various processes described herein.

The exemplary processing device 200 includes one or more (hardware) processors (also referred to herein as microprocessors 210 (or in the alternative, a system-on-chip (SoC) microcontroller that itself forms an integrated circuit that also includes memory and one or more peripherals) for executing instructions that make up a computer program and corresponding (hardware) memory 220 that are connected to a system bus 230.

Information can be passed between the system bus 230 (via a suitable bridge 240) and a local bus 250 that is used to communicate with various input/output devices. For instance, the local bus 250 is used to interface peripherals with the microprocessor(s) 210.

By way of non-limiting example peripherals can include devices such as storage devices 260 (for example, hard disk drives).

Another example of peripheral(s) includes removable media storage devices 270 (for example, flash drives, DVD-ROM drives, CD-ROM drives, floppy drives or the like).

Yet another example of peripherals includes I/O devices 280 such as input device (for example, mouse, keyboard, scanner or the like) output devices (for example, monitor, printer or the like). In another form, the I/O devices 280 may include various display screens, such as those available on a computer, laptop, mobile telephone, smart watch, graphical user interface (GUI) or other related data-reporting device, including those placed upon or otherwise readily accessible to the individual being monitored. Such display screens cooperate with the processing device 200 such that a program stored in memory 220 and executed by the one or more microprocessors 210 can convey to a user an indication on the I/O device 280 of the location (or other desired information) of the asset of interest 108.

Still further, an example peripheral can include a network adapter 290.

The present list of peripherals is mentioned by way of illustration and is not intended to be limiting. Other peripheral devices may be suitably integrated into the processing device 200. In a similar manner, all such devices and variants thereof are within the scope of the present disclosure.

The one or more microprocessors 210 control operation of the exemplary information processing device 124. Moreover, one or more of the microprocessors 210 execute computer-readable code (for example, stored in the memory 220, storage 260, removable media insertable into the removable media storage 270 or combinations thereof, collectively or individually referred to as computer-program products) that instructs the one or more microprocessors 210 to implement the computer-implemented processes herein that may be in the form of a machine-executable process executed on the information processing device 124, or on any other structure described more fully herein.

Thus, the processing device 200 or components thereof can implement processes (including computer-implemented processes) that are stored on the memory 220 as well as one or more computer-readable storage devices 260, 270 as set out in greater detail herein. Computer-program code (also referred to herein as machine code) for carrying out operations for aspects of the present disclosure may be written in any combination of one or more programming languages. This code may execute entirely or partially on the processing device 200, the latter in cases where distributed computing or related analysis is being utilized. In the latter scenario, a remote computer may be connected to the processing device 200 through any type of network connection, for example, using the network adapter 290 of the processing device 200.

In implementing computer aspects of the present disclosure, any combination of computer-readable medium may be utilized. The computer-readable medium may be a signal medium (that is to say, transitory propagating signal per se, whether as baseband or as part of a carrier wave, in either event as one that does not encompass a computer-readable storage medium), a computer-readable storage medium, or a combination thereof. Moreover, a computer-readable storage medium may be implemented in practice as one or more distinct mediums. Unlike transitory signals, such computer-readable storage medium (such as memory 220 or the computer-readable storage devices 260, 270) is a tangible device or related piece of hardware that can retain and store a program (instructions) for use by or in connection with an instruction execution system, apparatus or device, for example, a computer or other processing device such as the processing device 200 which is set out more fully herein. Specific examples (a non-exhaustive list) of the computer-readable storage medium include the following: a hard disk, a random-access memory (RAM), a read-only memory (ROM), an erasable programmable read-only memory (EPROM), flash memory, a portable computer storage device, an optical storage device such as a compact disc read-only memory (CD-ROM) or digital video disk (DVD), or any suitable combination of the foregoing. In particular, a computer-readable storage medium includes computer-readable hardware such as a computer-readable storage device, for example, the aforementioned memory 220. As such, a computer-readable storage device and computer-readable hardware are physical, tangible implementations that are non-transitory in that the content will persist until acted upon, for example, by removing power, by overwriting, deleting, modifying or the like. More-over, since hardware comprises one or more physical elements or components of a corresponding computer system (such as information processing device 124), hardware does not encompass software per se.

It will be appreciated that the processing device 200 may be configured into numerous form factors all of which are within the scope of the present disclosure. For example, in one form, the processing device 200 may be configured as part of the asset conveyance mechanism 110 (FIG. 1). In another form, the processing device 200 may be configured as a stationary on-site or off-site stationary device, while in another form to be miniaturized such that it may take on a portable form factor, e.g., a smartphone or tablet, or wearable processing device.

In still another form factor, the processing device 200 may be configured to be in the cloud. Communication within or by the processing device 200 may be through wired or wireless means where the latter may include known long-range or short-range approaches such as using a local area network, wide area network, etc., across the Internet, using mobile telephony, Wi-Fi, Bluetooth, nearfield communications or the like.

### Task Directed Tag Identification

Tasks can be utilized as a trigger to identify certain assets by their associated tags, as described in greater detail herein. Here, data that corresponds to the location of an asset conveyance mechanism (e.g., asset conveyance mechanism 110, FIG. 1), data that corresponds to one or more tags (e.g., tag 120, FIG. 1), or both may be maintained over a predetermined window of time. By analyzing identified tags over a defined time window, a tag corresponding to an asset of interest 108 can be uniquely identified.

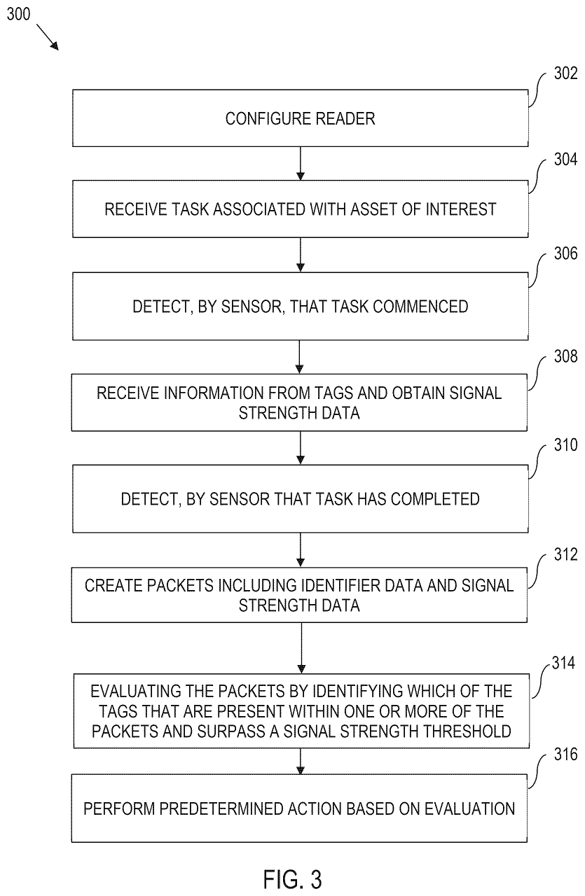

Referring to FIG. 3, a process 300 is illustrated for tracking assets within an asset-tracking space. The process 300 can be carried out within the tracking system 100 of FIG. 1 and/or using the processing device 200 of FIG. 2, using any combination of features described more fully herein. As such, the disclosures of FIG. 1 and FIG. 2 are incorporated by reference into the discussion of FIG. 3.

Following the process 300 of FIG. 3, at 302, a reader is configured to wirelessly detect tags within an asset-tracking space. For example, the reader may be an RFID reader that reads RFID tags within an industrial environment such as a warehouse, manufacturing plant, shipping location, etc. The tags may be coupled to (or otherwise associated with) assets that may easily be moved such as pallets, boxes, items, etc. or may be coupled with stationary objects such as racking, walls, etc. The reader receives communications from all tags within range.

In some embodiments, the reader polls the tags at discrete time intervals. For example, the RFID reader sends out a polling signal every one-hundred milliseconds and receives information back from the tags in response to the polling signal. Other time intervals may be used. In other embodiments, the reader continuously reads information from the tags.

At 304, a task is received, where the task identifies a tag within the asset-tracking space that is associated with an asset of interest. For example, a task to move a pallet with tag A from a first location to a second location in the industrial environment (i.e., a pick-and-place task) may be received. Thus, the asset of interest is the pallet with tag A.

At 306, the process detects that the task has commenced. As an illustrative example, a sensor (e.g., sensor 122, FIG. 1) may detect that the task has commenced. In an illustrative example, the process may detect the task at 306 by the sensor detecting that an asset (not necessarily the asset of interest) has been placed on an asset conveyance mechanism. For example, a pressure sensor, proximity sensor, etc., on the forks of a lift truck (i.e., asset conveyance mechanism) may detect that a pallet has been picked up by the lift truck. Here, the sensor sends a signal to a processor that indicates that the task has commenced. In this example, the processor may be on the asset conveyance mechanism, a remote information processing device (e.g., information processing device 124, FIG. 1), etc. As another example, an E-field sensor may detect an object on the lift truck. As a further example, a position switch may detect that an object (e.g., a pallet) is on the lift truck. Any appropriate type of sensor may be used to determine that the task has commenced. Thus, in certain implementations, the sensor (e.g., analogous to sensor 122, FIG. 1) is configured to detect whether an asset is placed on the asset conveyance mechanism. Note that the sensor may not know if the asset of interest is placed on the asset conveyance mechanism. Rather, the sensor may only be able to infer that an asset has been placed on the asset conveyance mechanism, e.g., where the sensor does not read tags.

In some embodiments, data from the asset conveying mechanism can be used to determine that the task has commenced. For example, in a lift truck, a vehicle network bus communicates data between different components (e.g., traction control, steering control, hydraulics control, etc.) and sensors (e.g., weight, accelerometer, gyroscope, encoders, etc.). Such data may identify whether the asset conveyance mechanism is idle, making an approach, carrying out a pick operation, carrying a load, dropping a load, departing from a pick and/or drop location, etc. Thus, the data from the asset conveying mechanism can be used to determine the start of a task.

At 308, the reader (e.g., the reader 114, FIG. 1) receives information from tags within range. For instance, the reader can obtain unique identifier data (e. g,, a tag identifier, a UUID, etc.) from each tag in range. In some implementations, the reader is active, even before and/or after the task is actively performed. However, reads that are performed outside the scope of designated task may be ignored by the information processing device to reduce the amount of data that is to be processed. The ability to ignore reads by the reader is not limited to time. As another example, range and/or location can be utilized to exclude certain reads. For instance, if the reader carries out a read operation that occurs outside a designated work area, then it may be desirable to ignore those reads. As another example, extrinsic data may be utilized to affect reads. For instance, if an asset conveyance mechanism unexpectedly stops or changes tasks, the process of reading tags can be adjusted. As yet another non-limiting example, it may be desirable to suspend or otherwise adjust reads in response to congestion or other temporary environmental conditions. In other implementations, the reader can be switched off, e.g., physically, virtually, etc., such as before or after tasks, when out of range of a work area, etc.

However, in other implementations, data obtained by the reader may be processed, e.g., by the information processing device, regardless of whether a task is being performed or not. For instance, the information processing device may utilize data extracted from the reader for other purposes or applications.

Further, in some implementations, the data acquired by the reader may be too voluminous to perform operations on that data in real time or in functional real time, e.g., to identify an asset of interest, to determine whether a task is being performed properly, or to make other decisions. As such, according to aspects of the present disclosure, data can be selectively ignored, dumped, not processed, filtered, batch processed, processed in non-real time, etc. As a few examples, an asset conveying mechanism can continue on to a next task while data from a previous task is processed, e.g., by an information processing device.

In some embodiments, the tag reader associates timestamps with the received data. As discussed above, the reader may sample the tags at discrete time intervals. As such, the time stamp provides a way for the collected data to be ordered/synchronized, etc.

Further, when the information is received from the tags, position, orientation, proximity (e.g., distance), and/or other data can be obtained and associated with the collected tag information. By way of example, signal strength data (e.g., RSSI) of a communication from the read tags can be obtained. For example, if the reader receives information from three tags, then the reader (or some other processor) can determine the signal strength for the communications from each of those tags and associate timestamps with each of those communications. The signal strength data may be weighted depending on a state of the asset conveyance mechanism (e.g., to account for motion-state-based noise suppression, to reduce weight of tags read while turning, to suppress reads while accelerating/decelerating, for motion conditions mapped to anti-noise filters, etc.). In some embodiments, other indicators instead of signal strength may be used. For example, angle of attack, time of flight, time of arrival, time-distance of arrival, etc. may be used instead of a signal strength identifier.

At 310, the process detects that the task has completed. For instance, the process may utilize the sensor (e.g., the sensor 122, FIG. 1) to detect that the task has been completed. As an illustrative example, the process 300 can utilize the sensor to detect that the asset (not necessarily the asset of interest) has been removed from the asset conveyance mechanism. Again, similar to determining that task has commenced, a similar reading from the sensor can be used to determine that the asset that was on the asset conveyance mechanism is off the asset conveyance mechanism, which signals that the task has been completed. Similarly to detecting that the task has commenced, in some embodiments, data from the asset conveying mechanism can be used to determine that the task has been completed.

At 312, packets are created. For instance, the process can create packets that include the identifier data of each of the tags, and the associated signal strength measured for each of those tags. For example, assume that the reader detects three tags (tag 1 having identifier A, tag 2 having identifier B, and tag 3 having identifier C) at a given time interval. A packet for that time interval can be created with the three identifiers (A, B, and C) along with their signal strengths. As an illustrative example, assume a signal strength of 30 for Tag 1 when reading identifier A, signal strength of 80 for Tag 2 when reading identifier B, and a signal strength of 100 for Tag 3 when reading identifier C. Thus, the packet would include (A, 30; B, 80; and C, 100). The process is repeated for each read cycle of the tag reader. This results in a set of packets that can be chronologically sequenced to correspond with the task. These packets can be created for the times when the reader is active, e.g., in functional real time (e.g., between successive reads by the reader). In other implementations, the packets are created only after the task has commenced and before the task has been completed. In still other implementations, the packets are created in non-real time, e.g., via batch processing, etc. Here, the packets can be assembled any time, including after completion of the task. Other variations for when the packets are created are also available, as discussed herein.

In an example application, the process is directed to an asset of interest, e.g., to determine where an asset of interest has been placed. In this example, the packets near the time when the task is detected as starting are of interest. Further, the packets near the time when the task is detected as ending are of interest. In some embodiments, all of the packets between the start and the end of the task are of interest. In various embodiments a subset of the packets between the start (or near the start) and the end (or near the end) of the task are of interest.

At 314, the packets are evaluated. For instance, the packets may be evaluated at 314 to determine which tag identifiers are in one or more of the packets and that surpass a signal strength threshold. In some embodiments, the signal strength threshold may be a predetermined, fixed value. In other embodiments, the signal strength threshold may be a dynamic threshold, where the threshold is based on the obtained signal strengths (e.g., an average, a median, some other formula, etc.). If there is a common tag identifier among all or a majority of the packets of interest, then that identifier is likely associated with the asset of interest 108. For example, if tag B is the only tag that is in all the packets and has a high signal strength, then it can be inferred that tag B must be closest to the reader on the truck. In some embodiments, the tag identifier that is likely associated with the asset of interest 108 is the tag identifier that appears in more of the packets than any other tag identifier. In various embodiments, the tag identifier that is likely associated with the asset of interest 108 is the tag identifier, when weighted by the signal strength, surpasses all other tags when weighted by their signal strengths. Other variations of using the presence of a tag identifier and associated signal strengths may also be used (e.g., RSSI trend slope analysis).

At 316, a predetermined action is performed based on the evaluation of 314. For example, assume that the evaluation at 316 determines that tag B is the only common tag identifier in the packets having a signal strength above the signal strength threshold. If the task is to move an asset associated with tag B, then the predetermined action may be to verify that the task was completed successfully. Thus, the location of the asset associated with tag B is known, and that location is written to a database or some location-tracking application. However, if the asset to be moved is an asset associated with tag A, then the predetermined action may be to send an alert that an incorrect asset was moved. If there is no common tag identifier in the packets, then an alert may be provided that a tag is missing or some other error occurred. A confidence score may be calculated (e.g., based on signal strength, time of flight, etc., or combinations thereof) for whether the identified tag is the tag for the asset of interest, and if the confidence score does not surpass a threshold, then a prompt may be displayed on a screen of the asset conveying mechanism

In some embodiments of the process 300, the signal strength data is not obtained or used in the evaluation. Instead, there is just an evaluation to find tag identifiers that are in all the evaluated packets.

### Example Implementation

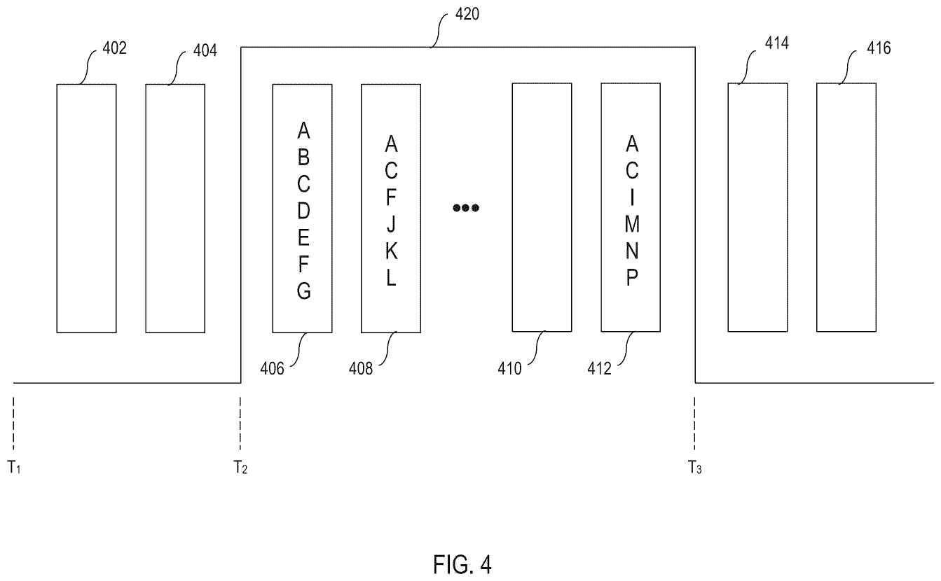

Referring next to FIG. 4, an example of the foregoing process 300 is illustrated. Assume in this example that a vehicle with an RFID tag reader and a proximity sensor, receives a pick-and-place task associated with an asset of interest at time T₁. In this specific example, the pick-and-place operation is to move an asset of interest (e.g., the asset of interest 108, FIG. 1) (in the form of a package, a pallet, etc.) from one location in a warehouse to another location in the warehouse.

In operation, the process detects when a task has begun. For instance, the proximity sensor may detect when a pallet (not necessarily the asset of interest) is on the vehicle. In some implementations, vehicle data, such as forklift telemetry data can be used in lieu of, as supplemental inputs to the proximity sensor data. As a few illustrative examples, optional forklift signals that may refine task window boundaries can include, for example, fork height, mast tilt angle, forklift acceleration or deceleration, inertial measurement unit (IMU)/gyro data, lift cylinder pressure, vibration signatures indicating lift or drop, etc.

In a practical application, RFID windowing logic can define a “Start packet” as first valid RFID read after load-present. Similarly, an “End packet” can be defined as the last valid RFID read before a load-absent condition. In some implementations, packets and windows for collecting packets can be dynamically sized. For instance, pick/drop windows, e.g., based on forklift action (slowing, stopping, lifting), can be utilized to obtain relatively more accurate window processing, e.g., by applying velocity-aware or motion-aware window adjustments. Between the start packet and the end packet, the system may keep the intermediate packets (e.g., for other applications). Alternatively, the system can ignore mid-task packets. For instance, some applications consider these intermediate packets as motion-contaminated signals.

As a few additional examples, camera/barcode fusion, barcode scanning during lift, image capture of pallet face, optical confirmation of pallet ID, fusion with RFID identification can be utilized to improve the confidence in the analysis of the process, e.g., by identifying the start and end of the process, by evaluating packets, etc.

Still further, aspects herein can utilize predictive load identification, e.g., by extracting data from a database that characterizes historical and/or predictive data. For instance, the process herein can use past pick patterns, anticipate next likely pallet ID, weight predictions against real-time RFID reads, etc.

Before and after receiving the task, the RFID tag reader data may be processed, or ignored. However, during operation of the task, packets are collected as discussed above. For instance, a time sequence of packets (each packet including signal identifiers and corresponding signal strength measurements) is periodically (for example, once every 100 milliseconds) collected, such as by receiving data associated with nearby RFID tags and obtaining their associated signal strengths. In the example shown, eight packets 402, 404, 406, 408, 410, 412 and 414 of tag identifiers (e.g., each packet includes several identifiers of tags read by the reader), signal strength indicators (for example, RSSI), and timestamps are obtained by the tag reader. An output of the proximity sensor is designated 420 and includes three times of interest: time T₁ (received task), time T₂ (sensor determines that the task has started), and time T₃ (the sensor determines that the task has ended).

At time T₂, the proximity sensor detects that an object is on the vehicle (for example, supported on the forks of a forklift truck). FIG. 4 schematically represents this by signal 420 going active. Responsive thereto, a processor on (or off) the vehicle determines that the task has commenced. The next packet 406 received includes identifiers for tags A, B, C, D, E, F, and G (as assets associated with those tags are nearby), along with a signal strength associated with each of the tag identifiers (e.g., with six identifiers, there are six signal strengths). The vehicle and tag reader are agnostic to what assets are associated with each of the tag identifiers. thus, it is unknown which asset is on the vehicle.

As the vehicle moves throughout the warehouse to a destination designated in the received task, more tag information is received and concatenated into packets. Those new packets may have different RFID tag identifiers in the packets. For example, at a midpoint, the RFID tag identifiers in a received packet may be A, C, F, J, K and L. As shown, there are eight packets shown, but there are many more packets created from tag information received during the task as indicated by the ellipses between packet 408 and 410.

After the vehicle reaches the destination in the task and unloads the pallet, the proximity sensor detects that there is no pallet on the vehicle, so the processor indicates that the task has ended at time T₃. Note that the sensor 122 may not be making the determination that the task has started or ended, but rather that information from the sensor 122 is used to determine that such task has started or ended. The packet created before the end of task (packet 412) includes RFID tag identifiers A, C, I, M, N and P and their associated signal strengths

After the task is determined to be completed, two (or more) packets of interest are compared. In this example, packet 406 is a packet of interest for the start of the task and packet 412 is the packet of interest for the end of the task. In packet 406, only A, C, and E have signal strengths that pass a threshold, so the other tag identifiers are ignored. In packet 412, only A, C, M, and P have signal strengths that pass a threshold, so the other tag identifiers are ignored. A comparison of the leftover identifiers provides that only tags A and C were detected at the start of the task and at the end of the task. Therefore, those are the common tags of interest.

Those tags are checked against a payload for the pallet to determine if the correct pallet (i.e., the asset of interest 108) was moved in the pick-and-place operation. In this example, a server determines that items associated with tags A and C are in the asset of interest, so a correct pick-and-place operation was performed, and an indication that the task was successful is supplied.

While the example of FIG. 4 indicates that the first packet after detecting the task has started and the last packet received before the task has ended are used, other packets near the start and end of the task may be used. For example, packet 404 may be used at the start (even though the task has not started until time T₂) and packet 410 or packet 414 may be used at the end of the task. Also, any or all of the packets may be used 704-714.

### Example Process

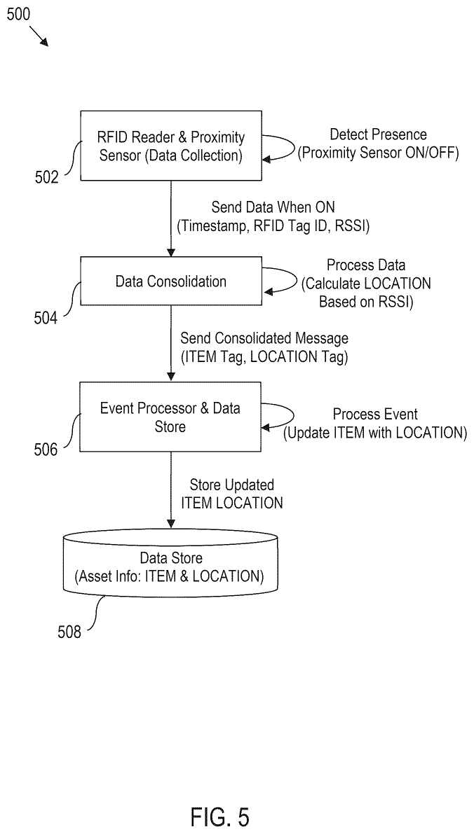

Referring next to FIG. 5, a non-limiting example process 500 shows how the data collection and processing that is enabled by the tracking system 100 of FIG. 1 takes place. At 502, the reader collects data (e.g., unique tag identifiers) from tags in an environment, and the sensor (e.g., proximity sensor) determines whether there is a presence of an asset on an asset-conveying device. Thus, the reader 114 and sensor 122 of FIG. 1, together perform data collection and consolidation. As can be seen, various types of data may be collected, obtained, or both (such as timestamp, unique identification, RSSI or related signal strength) and placed in condition for processing or consolidation. The processing of the data may take place in the information processing device 124 of FIG. 1 or elsewhere, such as in the cloud, on a server or (if suitably equipped with computing functionality) the reader 114.

At 504, a processor (either the same processor as indicated above or a different processor) consolidates the data (including the unique identifier for the tag) into packets with timestamps. Then, at 506, the packets are processed and compared, and an asset (or item) is updated with a location based on the processing, comparison, or both. For example, if a tag identifier is located in all or a majority of the packets or appeared more than other tag identifiers during a time window corresponding to a task for an asset of interest. That tag identifier was most likely on a vehicle (or another asset-conveying device) for that task. Other methods may be used to determine which tag identifier is associated with the asset of interest, as discussed above. At 508, the asset (item) and location are stored in a data store.

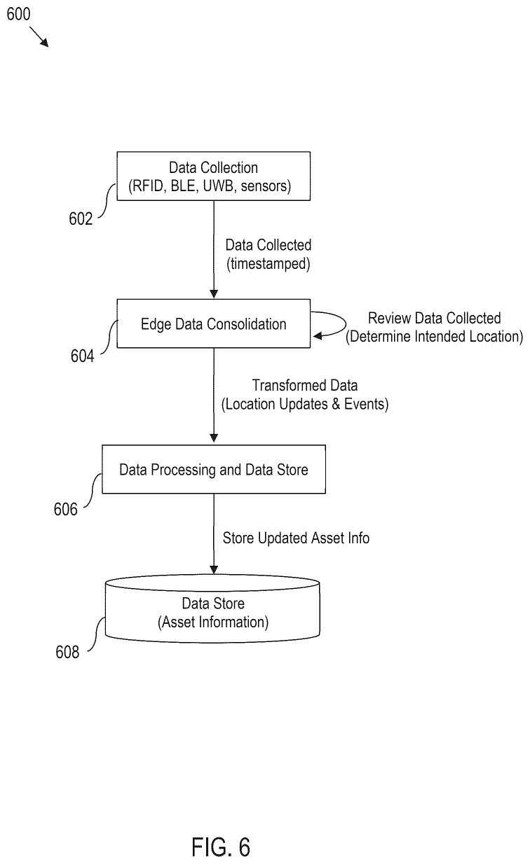

Referring now to FIG. 6, a process for tracking assets in an environment is shown. Similarly to the process of FIG. 5, at 602, different sensors (RFID, Bluetooth, ultra-wide band, etc.) disposed in an environment may be used to collect tag data (including tag identifiers) and obtain signal strengths, timestamps, etc. associated with the data. At 604, a processor consolidates the data into packets with timestamps, event data, or both. At 606, the packets are processed (similarly to above) and location information is derived for any assets of interest. At 608, the asset (item) and location are stored in a data store.

The processes 500 and 600 of FIGS. 5 and 6, respectively, may be used together or independently of each other. For example, the process 500 of FIG. 5 may be used to track assets moving on a mobile asset conveyance mechanism (e.g., a lift truck), and process 600 may be used to track assets moving on a fixed asset conveyance mechanism (e.g., a conveyor). Thus, asset locations may be known regardless of how the asset is moved.

### Computational Intelligence

With reference to the FIGURES herein, according to aspects herein, any two or more packets can be utilized to derive intelligence. As an example, the information processing device can carry out an RSSI trend slope analysis. As an illustrative example, the information processing device can compare RSSI slope data from two packets, e.g., from the start packet to the end packet. A positive slope can indicate approaching a correct location. A negative slope can indicate moving away from incorrect candidate. As another example, slope can be utilized as a weighting factor for location-tag scoring.

As another example, the information processing device can implement a location-tag scoring model. In this example, the model can score persistence during start and end windows, score relative RSSI strength, score RSSI slope, score consistency between pickup and placement positions, select the highest scoring fixed location tag, etc.

According to certain aspects herein, a motion state machine can be utilized to effectively carry out processes herein. For instance, a state machine can be utilized to distinguish transactional/motion states associated with an asset conveyance mechanism, e.g., to identify whether the asset conveyance mechanism (e.g., forklift) is idle, making an approach, carrying out a pick operation, carrying a load, dropping a load, departing from a pick and/or drop location, etc.

According to certain implementations, RFID read behavior may be weighted differently depending on motion state, e.g., as identified by the above state machine. As a few illustrative examples, RFID read behavior may be weighted to account for motion-state-based noise suppression, to reduce weight of tags read while turning, to suppress reads while accelerating/decelerating, for motion conditions mapped to anti-noise filters, etc.

Aspects herein can be extended to address relatively more complex situations, e.g., multiple nested assets on a pallet. Here, the processes described herein can be utilized to identify a primary pallet tag, associate secondary tags (cases/items), include nested items in an event record, distinguish pallet-level vs item-level identity, etc.

Moreover, the information processing device can carry out additional computations, e.g., by performing a multi-packet comparison (e.g., even beyond the first/last reads of a task). The process can also compare “packet bands” (early/mid/late), compare statistical summaries (median, max), compare filtered sub-windows (e.g., last 2 seconds of load-on), etc.

According to further aspects herein, machine learning, artificial intelligence (ML/AI) assisted enhancements, such as for ML-based prediction of pick/drop events, ML-driven refinement of pick/drop windows, ML-based scoring of candidate pallets, anomaly detection for bad reads or incorrect placements, etc.

Aspects herein may further comprise vehicle-to-infrastructure messaging, such as real-time pick/drop broadcast to a Warehouse Management System (WMS), task validation, automatic correction prompts, forklift-to-door/zone signaling, etc. In this regard, an asset conveyance mechanism (e.g., industrial vehicle), may include an in-cab display/operator interface. For instance, a forklift may include an integrated in-cab screen or tablet mounted within the operator's field of view.

In this regard, the display may show information to an operator, such as the detected pallet ID, the intended destination location (rack/slot), the detected destination location (rack/slot), a confirmation of successful pick or drop, error states (e.g., “multiple pallets detected,” “no valid location tag found”), forklift task status (idle, pick, carry, drop, depart), warnings when a pallet is placed in the wrong location, a visual confirmation of RFID reads during the pick/drop window, etc.

According to even further aspects herein, an in-cab user interface (UI) may display real-time signal indicators or “read health” metrics, etc. The display may show forklift location (if optional Bluetooth low energy/ultrawide band/GNSS forklift-positioning is used).

In some implementations, a vehicle operator can interact with the processes herein. For instance, operator interaction/overrides can be implemented. As a few examples, the operator may acknowledge a pick or drop event via a button or software interaction, the operator may initiate a manual override to force acceptance of a pallet or location, the interface may allow the operator to correct or confirm pallet identity, the system may block operation or alert the operator if an incorrect location is detected, etc.

In some implementations, the information processing device can augment its processes with task guidance/workflow integration. By way of example, a display may show assigned tasks (e.g., to a vehicle operator) fetched from warehouse management system or cloud gateway. The system may provide step-by-step pick/drop instructions. As a few additional examples, may confirm completion of tasks, a user interface may notify the operator of mismatches between expected and detected assets, etc.

Yet further, safety and compliance features may be provided. By way of non-limiting example, a user interface may warn an operator (e.g., of an asset conveyance mechanism) of system faults or misreads. A user interface may also warn the operator of nearby people. Still further, the display may integrate forklift safety indicators. As another example, the display may only show information when the forklift is stationary (safety compliance mode).

In some implementations, offline/sync modes can be utilized to extend and/or enhance the disclosed processes herein. As a few examples, an in-cab user interface of a corresponding asset conveyance mechanism may operate offline if network connectivity is lost. As another example, data may sync automatically when network connection returns. As yet another example, a user interface may queue completed tasks and RFID events for later upload.

According to some implementations, configurable operator profiles can be utilized to provide improved data analysis. For instance, different operators may log in and receive personalized user interface settings. Permissions may also limit override authority.

Still further, a cab display in the asset conveyance mechanism (e.g., forklift) may serve as a validation mechanism. By way of illustration, the system may require operator confirmation on ambiguous reads. As another example, the display may provide a “confidence score” or equivalent indicator.

### Miscellaneous

Within the present disclosure, it will be understood by one skilled in the art that aspects disclosed herein may be embodied as a system or process. It will be further understood that the operations, functions, logical blocks, modules, circuits and steps or events described may be implemented in hardware, software, firmware or any combination thereof.

Within the present disclosure, one or more of the following claims may utilize the term “wherein” as a transitional phrase. For the purposes of defining features discussed in the present disclosure, this term is introduced in the claims as an open-ended transitional phrase that is used to introduce a recitation of a series of characteristics of the structure and should be interpreted in like manner as the more commonly used open-ended preamble term “comprising” and its variants that do not preclude the possibility of additional acts or structures.

Within the present disclosure, terms such as “preferably”, “generally” and “typically” are not utilized to limit the scope of the claims or to imply that certain features are critical, essential, or even important to the disclosed structures or functions. Rather, these terms are merely intended to highlight alternative or additional features that may or may not be utilized in a particular embodiment of the disclosed subject matter. Likewise, it is noted that the terms “substantially” and “approximately” and their variants are utilized to represent the inherent degree of uncertainty that may be attributed to any quantitative comparison, value, measurement or other representation. As such, use of these terms represents the degree by which a quantitative representation may vary from a stated reference without resulting in a change in the basic function of the subject matter at issue.

Within the present disclosure, the use of the prepositional phrase “at least one of” is deemed to be an open-ended expression that has both conjunctive and disjunctive attributes. For example, a claim that states “at least one of A, B and C” (where A, B and C are definite or indefinite articles that are the referents of the prepositional phrase) means A alone, B alone, C alone, A and B together, A and C together, B and C together, or A, B and C together. By way of example within the present disclosure, if a claim recites that data is being acquired from at least one of a first sensor, a second sensor and a third sensor, and if such data is being acquired from the first sensor alone, the second sensor alone, the third sensor alone or any combination of the first, second and third sensors, then such data acquisition satisfies the claim.

Within the present disclosure, the singular forms “a,” “an” and “the” include plural references unless the context clearly dictates otherwise.

Within the present disclosure, the following claims are not intended to be interpreted based on 35 USC 112(f) unless and until such claim limitations expressly use the phrase “means for” or “steps for” followed by a statement of function void of further structure. Moreover, the corresponding structures, materials, acts and equivalents of all means or step plus function elements in the claims that follow are intended to include any structure, material or act for performing the function in combination with other claimed elements as specifically claimed.

The corresponding structures, materials, acts, and equivalents of all means or step plus function elements in the claims that follow are intended to include any structure, material or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

It will be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

What is claimed is:

1. A process of tracking, the process comprising:
configuring a reader to wirelessly communicate with tags within an asset-tracking space;
receiving a task, the task identifying a tag within the asset-tracking space that is associated with an asset of interest;
detecting, with a sensor, that the task has commenced by determining that an asset has been placed on an asset conveyance mechanism;
receiving, by the reader, information from the tags, wherein the information includes identifier data;
obtaining signal strength data for the tags received by the reader;
detecting, with the sensor, that the task has been completed by determining that the asset has been removed from the asset conveyance mechanism;
creating packets including the identifier data and signal strength data for the tags at a specific time;
evaluating the created packets by identifying which of the tags that are present within a select one or more of the packets, and surpass a signal strength threshold; and
performing a predetermined action based on the evaluation.

2. The process of claim 1, wherein:
the reader polls the tags at discrete time intervals; and
creating the packets includes creating a packet for each discrete time intervals, and information from every tag detected is included in the packet.

3. The process of claim 1, wherein the reader is active regardless of whether the task has commenced.

4. The process of claim 1, wherein the reader is only active when the task has commenced and before the task is completed.

5. The process of claim 1, wherein identifying which of the tags are present within the packets includes identifying which of the tags are present in a subset of the packets.

6. The process of claim 5, wherein the packets used to identify the tags include:
a start packet, where the start packet is associated with the time interval when the task has commenced; and
an end packet, wherein end packet is associated with the information when the task has been completed.

7. The process of claim 6, wherein identifying which of the tags are present within the packets includes identifying if a tag is present in the start packet and is present in the end packet and is not ignored in either the start packet or the end packet.

8. The process of claim 5, wherein the packets used to identify the tags include intermediate packets, which are associated with the information received in a time between when the task has commenced and completed.

9. The process of claim 8, wherein identifying which of the tags are present within the packets includes identifying if a tag is present and surpasses the signal strength threshold in each of the intermediate packets.

10. The process of claim 8, wherein identifying which of the tags are present within the packets includes identifying if a tag is present and surpasses the signal strength threshold in a subset of the intermediate packets.

11. The process of claim 5, wherein identifying which of the tags are present within the packets includes identifying if a tag is present and surpasses the signal strength threshold in each of the subset of packets.

12. The process of claim 1, wherein the predetermined action includes determining a location of the asset of interest within the asset-tracking space based on the evaluation.

13. The process of claim 1, wherein identifying which of the tags are present within the packets includes identifying if a tag is present and surpasses the signal strength threshold in each of the packets.

14. The process of claim 1, wherein the predetermined action includes verifying that the identified tag is the tag associated with the asset of interest.

15. The process of claim 1, wherein the signal strength threshold is dynamic.

16. The process of claim 1, wherein the signal strength threshold is a fixed value.

17. A process of tracking, the process comprising:
configuring a reader to wirelessly communicate with tags within an asset-tracking space;
receiving a task, the task identifying a tag within the asset-tracking space that is associated with an asset of interest;
detecting, with a sensor, that the task has commenced by detecting that an asset has been placed on an asset conveyance mechanism;
receiving, by the reader, information from the tags, wherein the information includes identifier data;
detecting, with the sensor, that the task has been completed by detecting that the asset has been removed from the asset conveyance mechanism;
creating packets including the identifier data for the tags at a specific time;
identifying which of the tags are present within the packets; and
performing a predetermined action based on the identified tags.

18. The process of claim 17, wherein identifying which of the tags are present within the packets includes weighting the tag identifiers by signal strength values associated with the tag identifiers.

19. A process of tracking, the process comprising:
configuring a reader to wirelessly communicate with tags within an asset-tracking space;
receiving a task, the task identifying a tag within the asset-tracking space that is associated with an asset of interest;
detecting, by analyzing data from an asset conveyance mechanism, that the task has commenced;
receiving, by the reader, information from the tags, wherein the information includes identifier data;
detecting, by analyzing data from the asset conveyance mechanism, that the task has been completed;
creating packets including the identifier data for the tags at a specific time;
identifying which of the tags are present within the packets; and
performing a predetermined action based on the identified tags.

20. The process of claim 19, wherein identifying which of the tags are present within the packets includes identifying a trend slope analysis of signal strength data.
